(19) United States
(12) Patent Application Publication
(10) Pub. No.: US 2017/0373552 A1
(43) Pub. Date: Dec. 28, 2017

(54) MOUNTING ASSEMBLY FOR ELEVATOR LINEAR PROPULSION SYSTEM

(71) Applicant: Otis Elevator Company, Farmington, CT (US)

(72) Inventors: Zbigniew Piech, Cheshire, CT (US); Wojciech Szelag, Poznan (PL); Cezary Jedryczka, Lniano (PL); Adam Marian Myszkowski, Ostrow Wlkp (PL); Enrico Manes, Feeding Hills, MA (US)

(21) Appl. No.: 15/538,085

(22) PCT Filed: Dec. 18, 2015
(86) PCT No.: PCT/US2015/066770

§ 371 Date: Jun. 20, 2017

Related U.S. Application Data
(60) Provisional application No. 62/095,183, filed on Dec. 22, 2014.

(51) Int. Cl. H02K 3/18; B66B 11/04; H02K 41/035; H02K 41/03

(52) U.S. Cl. CPC H02K 3/18; B66B 11/0407; H02K 41/035; H02K 41/031

(57) ABSTRACT

An elevator system includes an elevator car (14) to travel in a hoistway; and a linear propulsion system to impart force to the elevator car; the linear propulsion system including: a secondary portion (18) mounted to the elevator car; and a primary portion (16) mounted in the hoistway; the primary portion including: a mounting assembly (50) including: a mounting panel (52); a plurality of coils (51) mounted to the mounting panel; and a cover (70) secured to the mounting panel, the cover and mounting panel enclosing the coils.

### FIELD OF THE INVENTION

The subject matter disclosed herein relates generally to the field of elevators, and more particularly to a multicar, self-propelled elevator system having a linear propulsion system.

### BACKGROUND

Self-propelled elevator systems, also referred to as ropeless elevator systems, are useful in certain applications (e.g., high rise buildings) where the mass of the ropes for a roped system is prohibitive and there is a desire for multiple elevator cars to travel in a single lane. There exist self-propelled elevator systems in which a first lane is designated for upward traveling elevator cars and a second lane is designated for downward traveling elevator cars. At least one transfer station is provided in the hoistway to move cars horizontally between the first lane and second lane.

Existing self-propelled elevators employ linear motors having primary portions (e.g., stator coils) secured to a holding structure and embedded in a resin or plastic mold. Existing holding structures require additional measures to achieve stiffness along longitudinal axis of the primary portions. Existing holding structures may also create difficulties during assembly under restrictions of small tolerance. Existing holding structures may also require an outside support structure, which often increases the airgap between the primary portions and secondary portions of the linear motor.

### BRIEF DESCRIPTION

According to one embodiment, an elevator system includes an elevator car to travel in a hoistway; and a linear propulsion system to impart force to the elevator car; the linear propulsion system including: a secondary portion mounted to the elevator car; and a primary portion mounted in the hoistway; the primary portion including: a mounting assembly including: a mounting panel; a plurality of coils mounted to the mounting panel; and a cover secured to the mounting panel, the cover and mounting panel enclosing the coils.

In addition to one or more of the features described above or below, or as an alternative, further embodiments could include the mounting assembly is modular assembly, a plurality of mounting assemblies forming the primary portion.

In addition to one or more of the features described above or below, or as an alternative, further embodiments could include the secondary portion includes two secondary portions, the primary portion being positioned between the two secondary portions.

In addition to one or more of the features described above or below, or as an alternative, further embodiments could include the secondary portion includes two secondary portions, the primary portion includes two primary portions, the two primary portions being positioned between the two secondary portions.

In addition to one or more of the features described above or below, or as an alternative, further embodiments could include the mounting panel includes a base and a plurality of flanges extending from the base.

In addition to one or more of the features described above or below, or as an alternative, further embodiments could include the coils are mounted to the base.

In addition to one or more of the features described above or below, or as an alternative, further embodiments could include the cover extends over the base and the flanges.

In addition to one or more of the features described above or below, or as an alternative, further embodiments could include the mounting assembly includes a plurality of coil cores, the coil cores interposed between the mounting panel and the cover.

In addition to one or more of the features described above or below, or as an alternative, further embodiments could include the coils are supported on the coil cores.

In addition to one or more of the features described above or below, or as an alternative, further embodiments could include the mounting panel and the cover are made from a non-conductive material.

According to another embodiment, a mounting assembly for a linear propulsion system including a primary portion and a secondary portion, the mounting assembly comprising: a mounting panel; a plurality of coils mounted to the mounting panel; and a cover secured to the mounting panel, the cover and mounting panel enclosing the coils.

In addition to one or more of the features described above or below, or as an alternative, further embodiments could include the mounting assembly is modular assembly, a plurality of mounting assemblies forming the primary portion.

In addition to one or more of the features described above or below, or as an alternative, further embodiments could include the mounting panel includes a base and a plurality of flanges extending from the base.

In addition to one or more of the features described above or below, or as an alternative, further embodiments could include the coils are mounted to the base.

In addition to one or more of the features described above or below, or as an alternative, further embodiments could include the cover extends over the base and the flanges.

In addition to one or more of the features described above or below, or as an alternative, further embodiments could include the mounting assembly includes a plurality of coil cores, the coil cores interposed between the mounting panel and the cover.

In addition to one or more of the features described above or below, or as an alternative, further embodiments could include the coils are supported on the coil cores.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 depicts a multicar elevator system in an exemplary embodiment;

FIG. 2 depicts components of a drive system in an exemplary embodiment;

FIG. 3 is a top down view of a car and portions of a linear propulsion system in an exemplary embodiment;

FIG. 4 is a front view of portions of a linear propulsion system in an exemplary embodiment;

FIG. 5 is a partially exploded view of a mounting assembly for a stationary portion of a linear propulsion system in an exemplary embodiment; and

FIG. 6 is a perspective view of a mounting assembly for a stationary portion of a linear propulsion system in an exemplary embodiment.

### DETAILED DESCRIPTION

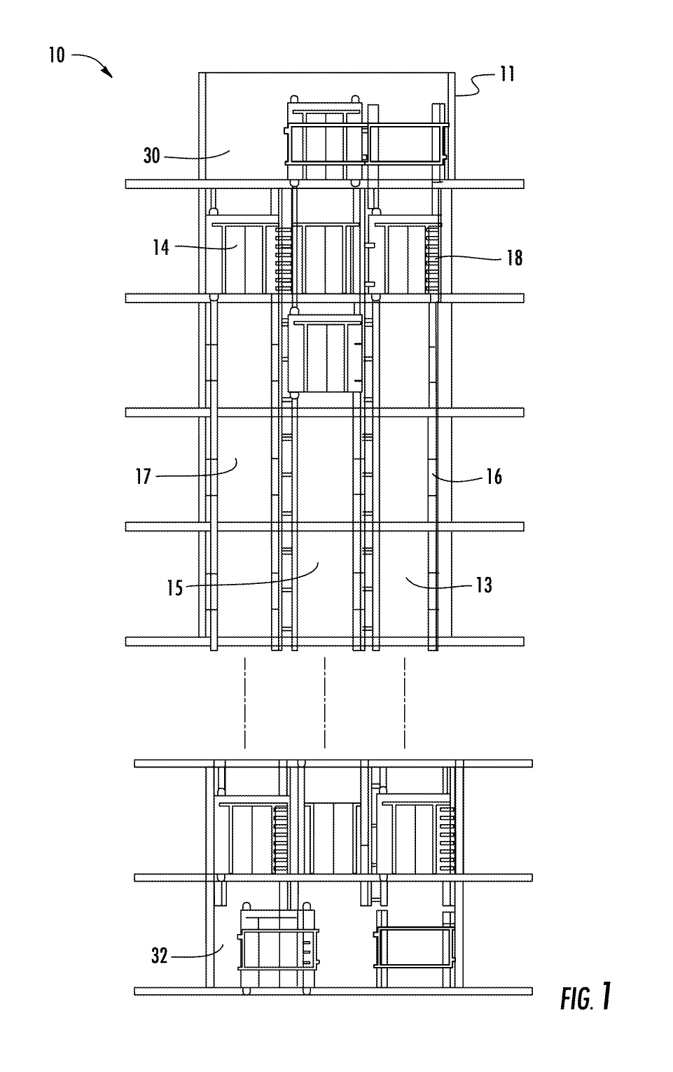

FIG. 1 depicts a multicar, self-propelled elevator system 10 in an exemplary embodiment. Elevator system 10 includes a hoistway 11 having a plurality of lanes 13, 15 and 17. While three lanes are shown in FIG. 1, it is understood that embodiments may be used with multicar, self-propelled elevator systems have any number of lanes. In each lane 13, 15, 17, cars 14 travel in one direction, i.e., up or down. For example, in FIG. 1 cars 14 in lanes 13 and 15 travel up and cars 14 in lane 17 travel down. One or more cars 14 may travel in a single lane 13, 15, and 17.

Above the top floor is an upper transfer station 30 to impart horizontal motion to elevator cars 14 to move elevator cars 14 between lanes 13, 15 and 17. It is understood that upper transfer station 30 may be located at the top floor, rather than above the top floor. Below the first floor is a lower transfer station 32 to impart horizontal motion to elevator cars 14 to move elevator cars 14 between lanes 13, 15 and 17. It is understood that lower transfer station 32 may be located at the first floor, rather than below the first floor. Although not shown in FIG. 1, one or more intermediate transfer stations may be used between the first floor and the top floor. Intermediate transfer stations are similar to the upper transfer station 30 and lower transfer station 32.

Cars 14 are propelled using a linear propulsion system having a fixed, primary portion 16 and a moving, secondary portion 18. The primary portion 16 includes windings or coils mounted at one or both sides of the lanes 13, 15 and 17. Secondary portion 18 includes permanent magnets mounted to one or both sides of cars 14. Primary portion 16 is supplied with drive signals to control movement of cars 14 in their respective lanes.

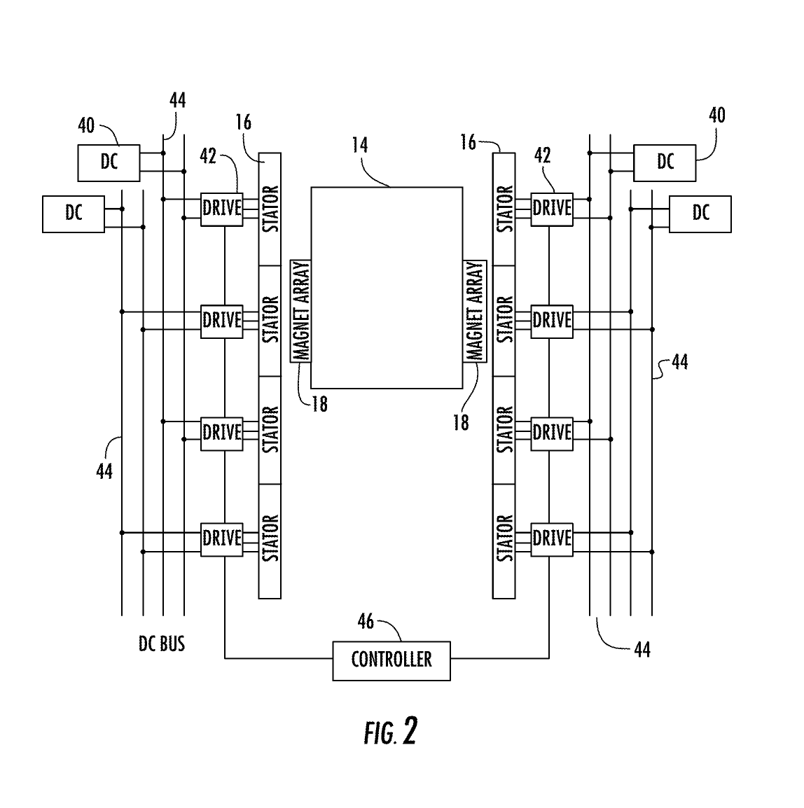

FIG. 2 depicts components of a drive system in an exemplary embodiment. It is understood that other components (e.g., safeties, brakes, etc.) are not shown in FIG. 2 for ease of illustration. As shown in FIG. 2, one or more power sources 40 are coupled to one or more drives 42 via one or more buses 44. In the example in FIG. 2, the power sources are DC power sources, but embodiments are not limited to using DC power. DC power sources 40 may be implemented using storage devices (e.g., batteries, capacitors). DC power sources 40 may be active devices that condition power from another source (e.g., rectifiers). Drives 42 receive DC power from the DC buses 44 and provide drive signals to primary portions 16 of the linear propulsion system. Each drive 42 may be a converter that converts DC power from DC bus 44 to a multiphase (e.g., 3 phase) drive signal provided to a respective section of the primary portions 16. The primary portion 16 is divided into a plurality of sections, with each section associated with a respective drive 42.

A controller 46 provides control signals to each of the drives 42 to control generation of the drive signals. Controller 46 may use pulse width modulation (PWM) control signals to control generation of the drive signals by drives 42. Controller 46 may be implemented using a processor-based device programmed to generate the control signals. Controller 46 may also be part of an elevator control system or elevator management system. Elements of FIG. 2 may be implemented in a single, integrated module, or be distributed along the hoistway.

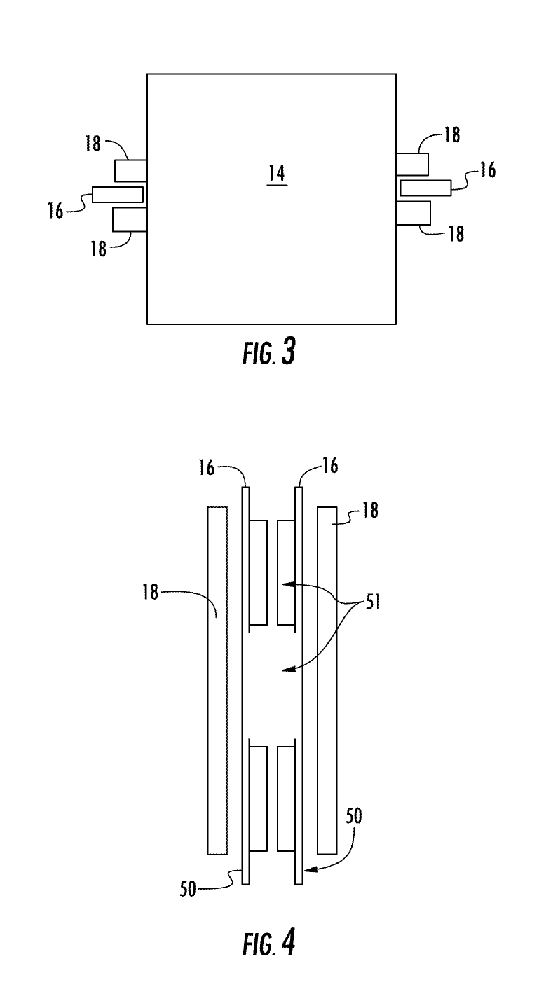

FIG. 3 is a top down view of a car 14 and portions of the linear propulsion system in an exemplary embodiment. A primary portion 16 of the linear propulsion system is mounted in the hoistway 11, on one or both sides of a lane. Car 14 mounts the secondary portion 18 of the linear propulsion system, on one or both sides of car 14. The primary portion 16 is positioned near a single secondary portion 18 or near more than one secondary portion 18 as shown in FIG. 3, where primary portion 16 is positioned between two secondary portions 18. In an exemplary embodiment, primary portion 16 includes a plurality of coils or windings. Secondary portion 18 may include permanent magnets. Drive signals applied to the primary portions 16 generate magnetic flux that imparts force on secondary portions 18 to move or hold car 14.

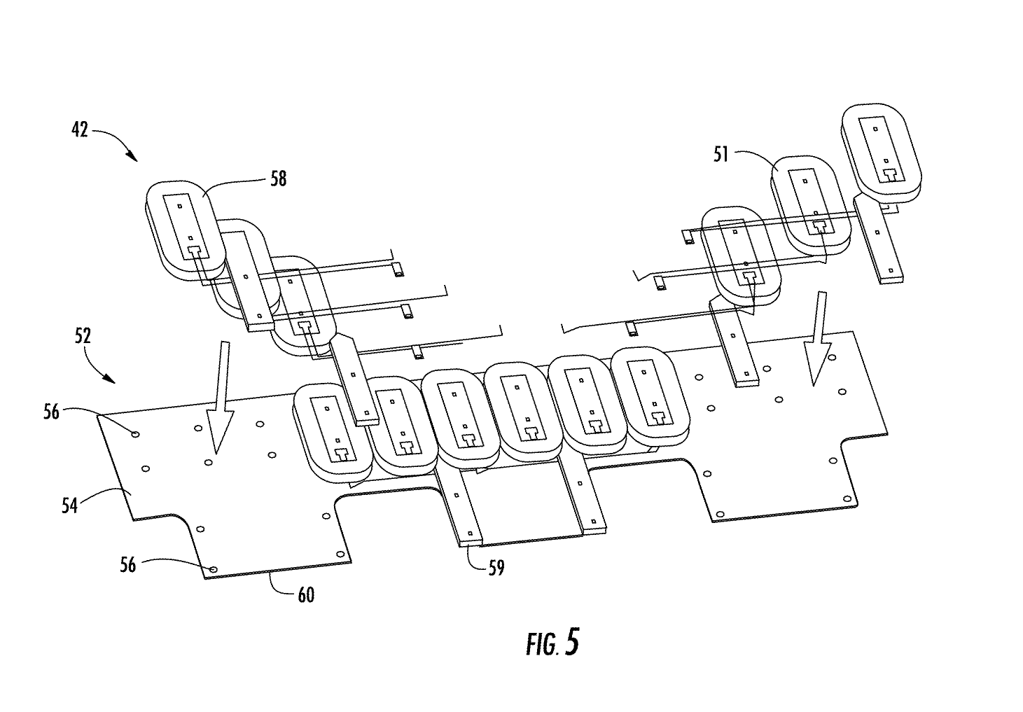

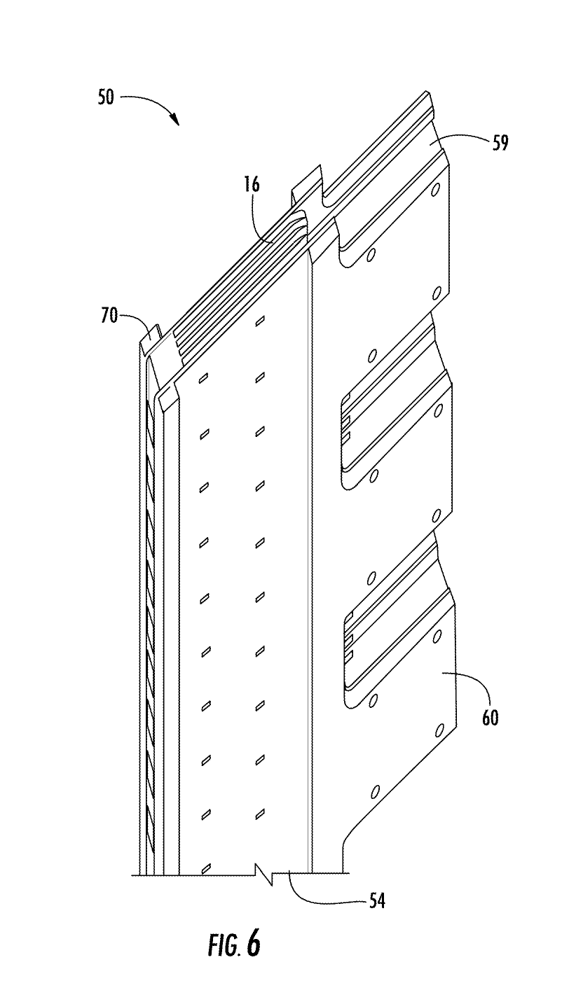

FIG. 4 is a front view of portions of a linear propulsion system in an exemplary embodiment. As shown in FIG. 4, secondary portions 18 (e.g., permanent magnets) are positioned on the outside of the primary portions 16 (e.g., coils). The primary portion 16 includes a plurality of modular mounting assemblies 50 (FIG. 5). As described in further detail herein, the primary portion 16 includes coils 51 secured in a mounting assembly 50 (FIG. 5). Two mounting assemblies 50 are arranged so that the coils 51 are adjacent to each other and positioned between two secondary portions 18.

FIG. 5 is a partially exploded view of a mounting assembly 50 for the primary portion 16 of the linear propulsion system in an exemplary embodiment. The mounting assembly 50 includes a mounting panel 52 that supports coils 51. Mounting panel 52 may be made from a non-conductive material, such as fiberglass or plastic. Mounting panel 52 includes a generally rectangular base 54 having a plurality of mounting holes 56 formed therein. Coil cores 58 are secured at the mounting holes 56 via fasteners. Coil cores 58 may be made from a non-conductive material, such as fiberglass or plastic. Coils 51 are supported on the coil cores 58.

Extending from base 54 are one or more optional flanges 60. Flanges 60 lie in the same plane as base 54. Flanges 60 include mounting holes 56 and spacers 59 may be secured at outer edges of the flanges 60 using fasteners. Flanges 60 provide a conduit to accommodate wiring to coils 51. Flanges 60 also improve rigidity of the mounting assembly 50.

FIG. 6 is a perspective view of an assembled mounting assembly 50 in an exemplary embodiment. A cover 70 is placed over the coils 51 and secured to coil cores 58 and spacers 59 with fasteners. Cover 70 may be made from a non-conductive material, such as fiberglass or plastic. Cover 70 extends over the base 54 and flanges 60. The mounting assembly 50 rigidly encloses the coils 51 in an enclosure including the base 54, cover 70, coil cores 58 and spacers 59.

As shown in FIG. 5, the mounting assembly 50 is a modular unit including a subset of the total number of coils 51 used in the primary portion 16 of the linear propulsion system. The coils 51 of each mounting assembly 50 may be driven by a single, respective drive 42. In other embodiments, a drive 42 may provide drive signals to coils 51 in multiple mounting assemblies 50. The modular nature of the mounting assembly 50 facilitates installation of the primary portions 16 along the length of the hoistway 11. Installers need only to handle the modular mounting assemblies 50, which are less cumbersome than existing designs.

Placing the coils 51 between base 54 and cover 70 is a compact design, and reduces the physical size of the primary portion 16 compared to existing designs. Therefore, the distance between coils 51 may be decreased, the electromagnetic airgap between surfaces of primary portions 16 and secondary portions 18 may be increased and/or the linear propulsion system dimensions may be reduced while the airgap remains constant. The improved stiffness of the mounting assembly 50 allows for easier maintaining of the airgap. Assembly costs may also be reduced, as the mounting assembly may be formed with lower precision machines. Base 54, cover 70, coil cores 58 and spacers 59 may be molded or cast in high quantity using a lower amount of materials. The modular nature of the mounting assembly 50 provides repeatable, structural features.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. An elevator system, comprising:
an elevator car to travel in a hoistway; and
a linear propulsion system to impart force to the elevator car;
the linear propulsion system including:
a secondary portion mounted to the elevator car; and
a primary portion mounted in the hoistway;
the primary portion including:
a mounting assembly including:
a mounting panel;
a plurality of coils mounted to the mounting panel; and
a cover secured to the mounting panel, the cover and mounting panel enclosing the coils.

2. The elevator system of claim 1, wherein:
the mounting assembly is modular assembly, a plurality of mounting assemblies forming the primary portion.

3. The elevator system of claim 1, wherein:
the secondary portion includes two secondary portions, the primary portion being positioned between the two secondary portions.

4. The elevator system of claim 1, wherein:
the secondary portion includes two secondary portions, the primary portion includes two primary portions, the two primary portions being positioned between the two secondary portions.

5. The elevator system of claim 1, wherein:
the mounting panel includes a base and a plurality of flanges extending from the base.

6. The elevator system of claim 5, wherein:
the coils are mounted to the base.

7. The elevator system of claim 5, wherein:
the cover extends over the base and the flanges.

8. The elevator system of claim 1, wherein:
the mounting assembly includes a plurality of coil cores, the coil cores interposed between the mounting panel and the cover.

9. The elevator system of claim 8, wherein:
the coils are supported on the coil cores.

10. The elevator system of claim 1 wherein:
the mounting panel and the cover are made from a non-conductive material.

11. A mounting assembly for a linear propulsion system including a primary portion and a secondary portion, the mounting assembly comprising:
a mounting panel;
a plurality of coils mounted to the mounting panel; and
a cover secured to the mounting panel, the cover and mounting panel enclosing the coils.

12. The mounting assembly of claim 11, wherein:
the mounting assembly is modular assembly, a plurality of mounting assemblies forming the primary portion.

13. The mounting assembly of claim 11, wherein:
the mounting panel includes a base and a plurality of flanges extending from the base.

14. The mounting assembly of claim 13, wherein:
the coils are mounted to the base.

15. The mounting assembly of claim 13, wherein:
the cover extends over the base and the flanges.

16. The mounting assembly of claim 11, wherein:
the mounting assembly includes a plurality of coil cores, the coil cores interposed between the mounting panel and the cover.

17. The mounting assembly of claim 16, wherein:
the coils are supported on the coil cores.
